(19) United States
(12) Patent Application Publication
(10) Pub. No.: US 2010/0312459 A1
(43) Pub. Date: Dec. 9, 2010

(54) INTERNAL COMBUSTION ENGINE CONTROLLER

(75) Inventor: Shintaro Utsumi, Toyota-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-shi, Aichi (JP)

(21) Appl. No.: 12/745,394

(22) PCT Filed: Nov. 6, 2008
(86) PCT No.: PCT/JP2008/070636

§ 371 Date: May 28, 2010

(30) Foreign Application Priority Data
Dec. 17, 2007 (JP) 2007-324519

(51) Int. Cl. F02D 41/30

(52) U.S. Cl. 701/106

(57) ABSTRACT

A controller (2) of the present invention includes a learning section which learns the property of fuel; a control section which controls combustion conditions (compression ratio, ignition timing, etc.) within a combustion chamber (CC) on the basis of the leaned property; and a supply-source-status detection section which detects a change in the statue of a fuel supply source (161) for supplying the fuel to a fuel injector (162). When a change in the status of the fuel supply source (161) is detected, before re-learning of the fuel property, the control section (2) shifts the combustion conditions based on the learned fuel property such that occurrence of anomalous combustion is suppressed.

### TECHNICAL FIELD

The present invention relates to an apparatus for controlling operation of an internal combustion engine (hereinafter referred to as an “internal combustion engine controller”).

### BACKGROUND ART

There have been proposed various internal combustion engines which can use a plurality of types of fuel. In particular, in recent years, active attempts have been made toward use of alternate fuel (use of bio-ethanol for gasoline engines and use of bio-diesel fuel for diesel engines). The mixing ratio of bio-fuel to gasoline or light oil varies greatly. For example, in the case of ethanol-containing gasoline fuel, its ethanol concentration varies greatly from “E3” (gasoline fuel whose ethanol content is x % is generally called Ex; this also applies to the following description) to “E85” and then to “E100,” whose ethanol content is 100%.

A known internal combustion engine of such a type includes a fuel property sensor (an alcohol concentration sensor, etc.) for detecting the property of fuel, and its operation is controlled on the basis of the property of fuel detected by the fuel property sensor (for example, microfilm of Japanese Utility Model Application No. S60-79279 (Japanese Utility Model Application Laid-Open (kokai) No. S61-194744), Japanese Patent Application Laid-Open (kokai) No. H5-5446, Japanese Patent Application Laid-Open (kokai) No. 2005-232997, etc.).

### DISCLOSURE OF THE INVENTION

Presently, the above-mentioned fuel property sensor is, in general, not very high in accuracy, and may deteriorate with time. Therefore, in the case of a conventional internal combustion engine of the above-mentioned type, when the property of fuel changes greatly due to refueling or the like, operation control suitable for the changed fuel property is not performed, which may cause troubles such as a drop in performance, and increase in exhaust emissions.

Specifically, the type of fuel may be changed as a result of, for example, refueling or switching from a main fuel tank to a sub-fuel tank. At that time, fuel which is high in concentration of ethanol having a high octane number (E85 or the like) may be switched to fuel whose ethanol concentration is low (E0, E3, E5, E10, or the like). In such a case, if combustion conditions suitable for the fuel whose ethanol concentration is high (a high compression ratio, an advanced ignition timing, etc.) are maintained, anomalous combustion, such as knocking or pre-ignition, may occur.

The present invention has been accomplished in order to solve the above-mentioned problem. That is, an object of the present invention is to provide an internal combustion engine controller which can perform proper operation control even when the property of fuel changes greatly due to refueling or the like.

An internal combustion engine controller according to the present invention comprises a learning section (learning means), a supply-source-status detection section (supply-source-status detection means), and a control section (control means).

The learning section is configured to learn a property of fuel. When the fuel is composed of a first component and a second component, the property of fuel may be the concentration of one of the components (e.g., the second component). For example, the first and second components can be used for combustion independently of each other, and the second component is higher in octane number than the first component (in a specific example, the first component is gasoline, and the second component is alcohol).

The supply-source-status detection section is configured to detect a change in the status of a supply source for the fuel to a fuel injector which injects the fuel. The change in the status may be performance of refueling, a change in the property of fuel caused by refueling, or switching between a plurality of fuel tanks which contain fuels having different properties (including switching from a main fuel tank to a sub-fuel tank).

The control section is configured to control combustion conditions (mechanical compression ratio, ignition timing, supercharging pressure) within a combustion chamber on the basis of the fuel property learned by the learning section. Further, in the present invention, the control section is configured such that, when the supply-source-status detection section detects a change in the status, the control section controls the combustion conditions based on the fuel property shifted to the direction of suppressing occurrence of anomalous combustion such as knocking within the combustion chamber compared to the combustion conditions based on the fuel property learned before the detection until the learning section learns the fuel property again.

A fuel property sensor is provided on the internal combustion engine. This fuel property sensor is configured to produce an output corresponding to the property of fuel. The fuel property sensor may be provided on the supply source or inserted into a fuel supply passage. The fuel supply passage is provided so as to connect the fuel injector and the supply source together.

In the internal combustion engine controller of the present invention having such a configuration, the learning section learns the fuel property. For example, this learning can be performed on the basis of a combustion status (outputs of a knock sensor and an air-fuel-ratio sensor) created as a result of injection of the fuel. On the basis of the learned fuel property, the control section controls the combustion conditions.

When the status of the supply source changes (e.g., refueling, switching from the main fuel tank to the sub-fuel tank, or a change in the property of fuel to be supplied to the fuel injector, which change is caused by the refueling or switching), the supply-source-status detection section detects the change in the status. For example, performance of refueling can be detected through detection of opening/closing of a fuel lid or through monitoring an output of a level sensor provided in a fuel tank. Further, a change in the fuel property can be detected on the basis of an output of the fuel property sensor.

When a change in the status of the supply source is detected, the control section controls the combustion conditions based on the fuel property shifted to the direction of suppressing occurrence of anomalous combustion within the combustion chamber compared to the combustion conditions based on the fuel property learned before the detection until the learning section learns the fuel property again. Specifically, the control section controls the combustion conditions on the basis of a concentration lower than the learned concentration. For example, the control section renders the mechanical compression ratio lower than a mechanical compression ratio corresponding to the learned fuel property. Alternatively, the control section causes an ignition timing to delay from an ignition timing corresponding to the learned fuel property. Alternatively, the control section renders a set supercharging pressure lower than a supercharging pressure corresponding to the learned fuel property.

As described above, according to the present invention, when a change in the fuel property is detected or estimated through detection of a change in the status of the supply source, until relearning of the fuel property is completed, the combustion conditions are controlled such that occurrence of anomalous combustion such as knocking is suppressed. Therefore, according to the present invention, even when the fuel property greatly changes due to refueling or the like, proper operation control can be performed.

The control section may be configured such that, when an alcohol concentration learned before the detection of the change is higher than a predetermined value, the control section controls, for a predetermined time, the combustion conditions on the basis of the learned alcohol concentration, and then controls the combustion conditions on the basis of an alcohol concentration lower than the learned alcohol concentration. Such control may be performed when a temperature associated with operation of the internal combustion engine (e.g., ambient temperature, intake air temperature, cooling-water temperature, etc.) is lower than a predetermined temperature. The temperature can be acquired by a temperature acquisition section (temperature acquisition means), or estimated through calculation or the like.

In general, in the case of a fuel which contains gasoline (the first component) and alcohol (the second component), when the concentration of alcohol, which is low in volatility, is high, startability of the internal combustion engine is poor. Further, at a point in time when the internal combustion engine is started after the engine was stopped for refueling or the like, in many cases, the fuel existing before refueling or the like (fuel existing at the time of the latest fuel property learning) may remain within the fuel supply passage.

Therefore, in the case where the alcohol concentration learned before refueling or the like is high, if the combustion conditions are shifted toward the low concentration side (i.e., the combustion conditions are shifted such that the combustion conditions become suitable for fuel having a low alcohol concentration) (a low compression ratio, etc.), startability may deteriorate further (in particular, at the time of cold start). In order to overcome such a drawback, in such a case, performance of the above-described combustion condition shift is delayed by a predetermined time (e.g., until the above-mentioned remaining fuel is estimated to have been consumed, engine speed reaches a predetermined speed, or a variation in idling speed falls within a predetermined range). Specifically, after controlling, for the predetermined time, the combustion conditions on the basis of the alcohol concentration learned before the detection of a change in the status of the supply source, the control section controls the combustion conditions on the basis of an alcohol concentration lower than the learned alcohol concentration. With this operation, occurrence of startup failure can be suppressed to a possible extent.

The internal combustion engine controller may further comprise a pump control section (pump control means). This pump control section is configured to control operation of a fuel supply pump inserted into the fuel supply passage. Further, in the present invention, the pump control section is configured to stop the fuel supply pump until startup of the internal combustion engine is requested.

In such a configuration, at the time of startup immediately after performance of refueling or the like, the operation of the fuel supply pump is stopped (its startup is delayed) until startup of the internal combustion engine is requested. With this control, the fuel whose property has not yet been learned after refueling or the like and is uncertain is prevented, to a possible extent, from being injected immediately after the startup. Therefore, occurrence of startup failure can be suppressed to a possible extent.

### BRIEF DESCRIPTION OF THE DRAWINGS

FIG. 1 is a schematic diagram showing the overall configuration of a system which includes an engine and a controller according to an embodiment of the present invention, which is adapted to control the engine.

FIG. 2 is a flowchart showing a specific example of operation (fueling determination) of the controller shown in the configuration shown FIG. 1.

FIG. 3 is a flowchart showing a specific example of operation (fuel property learning) of the controller shown in the configuration shown FIG. 1.

FIG. 4 is a flowchart showing a specific example of operation (mechanical-compression-ratio setting) of the controller shown in the configuration shown FIG. 1.

FIG. 5 is a flowchart showing a specific example of operation (ignition timing setting) of the controller shown in the configuration shown FIG. 1.

FIG. 6 is a flowchart showing a specific example of operation (supercharging pressure setting) of the controller shown in the configuration shown FIG. 1.

FIG. 7 is a flowchart showing a specific example of operation (catalyst protection quantity increase correction) of the controller shown in the configuration shown FIG. 1.

FIG. 8 is a schematic diagram showing the overall configuration of a system according to another embodiment which has a configuration modified from the configuration shown in FIG. 1.

FIG. 9 is a flowchart showing a specific example of operation (mechanical-compression-ratio setting) of the controller shown in the configuration shown FIG. 8.

FIG. 10 is a flowchart showing a specific example of operation (fuel-pump-startup control) of the controller shown in the configuration shown FIG. 8.

### BEST MODE FOR CARRYING OUT THE INVENTION

An embodiment of the present invention (the best mode contemplated by the applicant at the time of filing the present application) will next be described with reference to the drawings.

Notably, the following description of the embodiment merely describes a specific example of the present invention specifically to a possible extent so as to satisfy requirements regarding a specification (requirement regarding description and requirement regarding practicability) required under the law. Therefore, as described below, the present invention is not limited to the specific structure of the embodiment which will be described below. Various modifications of the present embodiment are described together at the end of the specification, because understanding of the consistent description of the embodiment is hindered if such modifications are inserted into the description of the embodiment.

<Overall Configuration of System>

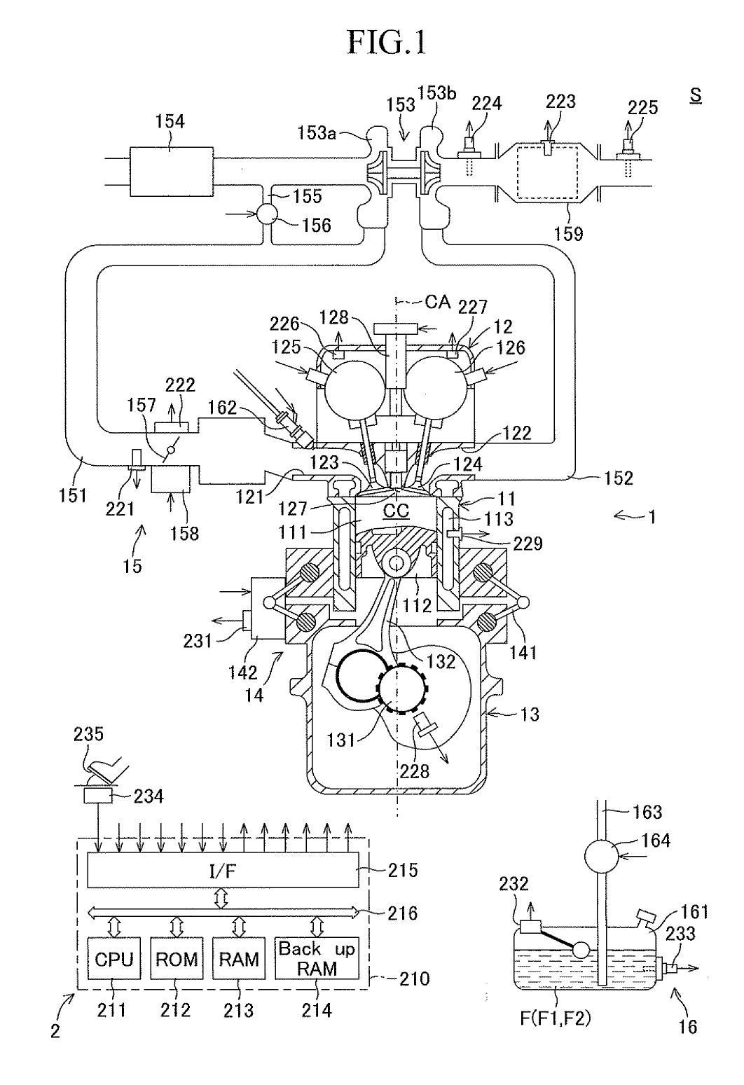

FIG. 1 is a schematic diagram showing the overall configuration of a system S (a vehicle or the like) which includes an engine 1, and an engine controller 2 (hereinafter, simply referred to as the “controller 2”) for controlling the engine. In the present embodiment, the engine 1 is configured such that it can use gasoline F1 (the first component of the present invention), bio-ethanol fuel F2 (the second component of the present invention), and a mixed fuel containing these fuels. The controller 2 according to the embodiment of the present invention is configured to control operation of the engine 1.

<<Engine>>

The engine 1 includes a cylinder block 11, a cylinder head 12, a crank case 13, a variable compression ratio mechanism 14, an intake-exhaust system 15, and a fuel supply system 16. In the present embodiment, as will be described later, the engine 1 is configured such that its mechanical compression ratio can be changed by the variable compression ratio mechanism 14.

<<<Engine Block>>>

A cylinder bore 111, which is a generally cylindrical through hole, is formed in the cylinder block 11 along a cylinder center axis CA. A piston 112 is accommodated within the cylinder bore 111 such that the piston 112 can reciprocate along the cylinder center axis CA. Further, a water jacket 113, which is a passage for cooling water, is formed around the cylinder bore 111.

A cylinder head 12 is joined to an upper end portion (an end portion on the side toward the top dead center of the piston 112) of the cylinder block 11. In order to prevent relative movement in relation to the cylinder block 11, the cylinder head 12 is fixed to the cylinder block 11 by means of unillustrated bolts or the like.

A plurality of recesses are provided on an end surface (a lower end surface in FIG. 1) of the cylinder head 12, which surface faces the cylinder block 11, at positions corresponding to upper end portions of the cylinder bores 111. When the cylinder head 12 is joined to the cylinder block 11, a combustion chamber CC is formed by a space within each cylinder bore 111 located above the top surface of the piston 112 (on the side toward the cylinder head 12) and a space within a corresponding one of the above-described recesses.

An intake port 121 and an exhaust port 122 are formed in the cylinder head 12. The intake port 121 is a passage for intake air supplied to the combustion chamber CC, and is provided to communicate with the combustion chamber CC. The exhaust port 122 is a passage for exhaust gas discharged from the combustion chamber CC, and is provided to communicate with the combustion chamber CC.

An intake valve 123, an exhaust valve 124, a variable intake valve timing apparatus 125, and a variable exhaust valve timing apparatus 126 are provided on the cylinder head 12 so as to control communications of the intake port 121 and the exhaust port 122 with the combustion chamber CC. The variable intake valve timing apparatus 125 and the variable exhaust valve timing apparatus 126 are configured to change the actual compression ratio by changing the open/close timings of the intake valve 123 and the exhaust valve 124. Since the specific configurations of the variable intake valve timing apparatus 125 and the variable exhaust valve timing apparatus 126 are well known, in the present specification, its detailed description will not be provided.

An ignition plug 127 and an igniter 128 are attached to the cylinder head 12. The ignition plug 127 includes a spark generation electrode provided at an end portion thereof such that the park generation electrode is exposed to an upper end portion of the combustion chamber CC. The igniter 128 includes an ignition coil for generating a high voltage to be applied to the spark generation electrode of the ignition plug 127.

A crankshaft 131 is rotatably supported within the crank case 13. The crankshaft 131 is connected with the piston 112 via a connecting rod 132 so that the crankshaft 131 is rotated as a result of reciprocating moment of the piston 112 along the cylinder center axis CA.

<<<Variable Compression Ratio Mechanism>>>

The variable compression ratio mechanism 14 of the present embodiment is configured to relatively move an assembly of the cylinder block 11 and the cylinder head 12 in relation to the crank case 13 along the cylinder center axis CA so as to change a clearance volume, to thereby change the mechanical compression ratio of the engine. This variable compression ratio mechanism 14 has a structure similar to those described in Japanese Patent Application Laid-Open (kokai) Nos. 2003-206771 and 2007-056837. Therefore, in the present specification, detailed description of this mechanism will not be provided, and only the outline thereof will be described.

The variable compression ratio mechanism 14 includes a coupling mechanism 141 and a drive mechanism 142. The coupling mechanism 141 couples the cylinder block 11 and the crank case 13 together such that the cylinder block 11 and the crank case 13 can move relative to each other along the cylinder center axis CA. The drive mechanism 142 includes a motor, a gear mechanism, etc., and is configured to move the cylinder block 11 and the crank case 13 relative to each other along the cylinder center axis CA.

<<<Intake-Exhaust System>>>

The intake-exhaust system 15 includes an intake passage 151, an exhaust passage 152, and a turbocharger 153. The intake passage 151 includes an intake manifold, a surge tank, etc., and is connected to the intake port 121. The exhaust passage 152 includes an exhaust manifold, and is connected to the exhaust port 122. The turbocharger 153 is interposed between the intake passage 151 and the exhaust passage 152. Specifically, the turbocharger 153 includes a compressor 153a and a turbine 153b. The compressor 153a is inserted into the intake passage 151, and the turbine 153b is inserted into the exhaust passage 152.

An air filter 154 is provided upstream of the compressor 153a with respect to the flow direction of intake air. Further, a bypass passage 155 is provided between a position on the intake passage 151 between the compressor 153a and the air filter 154 and a position on the intake passage 151 downstream of the compressor 153a. A supercharging pressure control valve 156 is inserted into the bypass passage 155. The supercharging pressure control valve 156 is composed of a solenoid valve, and the supercharging pressure of the compressor 153a can be adjusted by opening/closing the valve and adjusting the opening thereof.

A throttle valve 157 is inserted into the intake passage 151. The throttle valve 157 is disposed on the downstream side of the intake air exit of the bypass passage 155. This throttle valve 157 is rotated by a throttle valve actuator 158 composed of a DC motor.

A catalyst converter 159 is inserted into the exhaust passage 152. The catalyst converter 159 includes a three-way catalyst having an oxygen occlusion function, and is configured to remove HC, CO, and NOx from exhaust gas.

<<<Fuel Supply System>>>

The fuel supply system 16 is configured to feed a fuel F stored in a fuel tank 161 to an injector 162, and cause the injector 162 to inject the fuel F, to thereby supply the fuel into the combustion chamber CC. In the present embodiment, the injector 162 is configured and disposed to inject the fuel F within the intake port 121.

The fuel tank 161, which constitutes the supply source of the present invention, and the injector 162, which constitutes the fuel injector of the present invention, are connected together by means of a delivery pipe 163. A fuel pump 164 is inserted into the delivery pipe 163, which constitutes the fuel supply passage of the present invention. The fuel pump 164 is configured such that its drive is started and stopped in response to an electric signal from the outside.

<<Controller>>

The controller 2 of the present embodiment includes an engine electronic control unit (hereinafter, abbreviated to the “ECU”) 210, which constitutes the learning section, the control section, the supply-source-status detection section, the pump control section, and the temperature acquisition section of the present invention. The ECU 210 includes a CPU 211, ROM 212, RAM 213, backup RAM 214, an interface 215, and a bus 216. The CPU 211, the ROM 212, the RAM 213, the backup RAM 214, and the interface 215 are connected together by the bus 216.

The ROM 212 stores routines (programs) to be executed by the CPU 211, tables (lookup tables, maps) which are referred to when the CPU 211 executes the routines, parameters, etc. The RAM 213 temporarily stores data (parameters, etc.), if necessary, when the CPU 211 executes the routines. The backup RAM 214 stores data when the CPU 211 executes the routines in a state where the power is on, and holds the stored data even after the power is cut off.

The interface 215 is electrically connected to various sensors to be described later, and is configured to transmit to the CPU 211 output signals from these sensors. Further, the interface 215 is electrically connected to operating sections such as the variable intake valve timing apparatus 125, the variable exhaust valve timing apparatus 126, the igniter 128, the drive mechanism 142, the supercharging pressure control valve 156, the throttle valve actuator 158, the injector 162, the fuel pump 164, etc. The interface 215 is configured to transmit operation signals for operating these operating sections from the CPU 211 to these operating sections. That is, the controller 2 is configured to receive output signals from the above-mentioned various sensors via the interface 215, and send the above-mentioned operation signals to the respective operating sections on the basis of results of computation performed by the CPU 211 on the basis of the output signals.

<<<Various Sensors>>>

The system S includes various sensors, such as an air flow meter 221, a throttle position sensor 222, a catalyst bed temperature sensor 223, an upstream air-fuel-ratio sensor 224, a downstream air-fuel-ratio sensor 225, an intake cam position sensor 226, an exhaust cam position sensor 227, a crank position sensor 228, a cooling-water temperature sensor 229, an encoder 231, a fuel level sensor 232, a fuel property sensor 233, an accelerator opening sensor 234, etc.

The air flow meter 221 and the throttle position sensor 222 are attached to the intake passage 151. The air flow meter 221 is configured to output a signal corresponding to intake air flow rate Ga, which is the mass flow rate of the intake air flowing through the intake passage 151. The throttle position sensor 222 is configured to output a signal corresponding to the rotational phase of the throttle valve 157 (throttle valve opening TA). The catalyst bed temperature sensor 223 is attached to the catalyst converter 159. The catalyst bed temperature sensor 223 is configured to output a signal corresponding to catalyst bed temperature Tc.

The upstream air-fuel-ratio sensor 224 and the downstream air-fuel-ratio sensor 225 are attached to the exhaust passage 152. The upstream air-fuel-ratio sensor 224 is disposed upstream of the catalyst converter 159 with respect to the flow direction of exhaust gas. The downstream air-fuel-ratio sensor 225 is disposed downstream of the catalyst converter 159 with respect to the flow direction of exhaust gas. Each of the upstream air-fuel-ratio sensor 224 and the downstream air-fuel-ratio sensor 225 is configured to output a signal corresponding to the air-fuel-ratio of a fuel mixture supplied to the combustion chamber CC; i.e., the oxygen concentration of exhaust gas passing through the exhaust passage 152.

The intake cam position sensor 226 and the exhaust cam position sensor 227 are attached to the cylinder head 12. The intake cam position sensor 226 is configured to output a signal of a waveform having pluses corresponding to the rotational angle of an unillustrated intake cam shaft (included in the variable intake valve timing apparatus 125) for reciprocating the intake valve 123. Similarly, the exhaust cam position sensor 227 is configured to output a signal of a waveform having pluses corresponding to the rotational angle of an unillustrated exhaust cam shaft.

The crank position sensor 228 is attached to the crank case 13. The crank position sensor 228 is configured to output a signal of a waveform having pluses corresponding to the rotational angle of the crankshaft 131. Specifically, the crank position sensor 228 is configured to output a signal which includes a narrow pulse generated every time the crankshaft 131 rotates 10° and a wide pulse generated every time the crankshaft 131 rotates 360°. That is, the crank position sensor 228 is configured to output a signal corresponding to engine speed Ne.

The cooling-water temperature sensor 229 is attached to the cylinder block 11. The cooling-water temperature sensor 229 is configured to output a signal corresponding to cooling-water temperature Tw (the temperature of cooling water within the water jacket 113 of the cylinder block 11).

The encoder 231 is attached to the drive mechanism 142 of the variable compression ratio mechanism 14. The encoder 231 is configured to output a signal corresponding to the rotational angle or rotational phase of the motor or the like of the drive mechanism 142. That is, the ECU 210 can grasp the set mechanical compression ratio of the engine 1 on the basis of the output of the encoder 231.

The fuel level sensor 232 and the fuel property sensor 233 are attached to the fuel tank 161. The fuel level sensor 232 is configured to output a signal corresponding to the level of the fuel F within the fuel tank 161. The fuel property sensor 233 is an alcohol concentration sensor configured to output a signal corresponding to the concentration of the bio-ethanol F2 within the fuel F.

The accelerator opening sensor 234 is configured to output a signal corresponding to an operation amount Accp of an accelerator pedal 235 operated by a driver.

<Outline of Operation>

In the system S of the present embodiment, the controller 2 performs the following processing (control).

A target air-fuel-ratio is set on the basis of the engine speed Ne, the throttle valve opening TA, etc. This target air-fuel-ratio is usually set to a theoretical air-fuel-ratio. Meanwhile, if necessary, the target air-fuel-ratio can be set to a value slightly shifted from the theoretical air-fuel-ratio toward the rich side or the lean side.

A base fuel injection quantity Fbase is acquired from the target air-fuel-ratio set as described above, the intake air flow rate Ga, etc. In the case where a predetermined feedback control condition is not satisfied (e.g., the present time is immediately after startup of the engine 1, and the upstream air-fuel-ratio sensor 224 and the downstream air-fuel-ratio sensor 225 have not yet been warmed up sufficiently), open loop control based on the base fuel injection quantity Fbase is performed (in this open loop control, learning control based on a learned correction coefficient KG to be described later may be performed).

When the feedback control condition is satisfied after the upstream air-fuel-ratio sensor 224 and the downstream air-fuel-ratio sensor 225 have been activated, the base fuel injection quantity Fbase is corrected on the basis of a feedback correction coefficient FAF, whereby an instruction fuel injection quantity Fi, which represents an actual quantity of fuel injected from the injector 162, is acquired. The feedback correction coefficient FAF is acquired on the basis of the outputs from the upstream air-fuel-ratio sensor 224 and the downstream air-fuel-ratio sensor 225. The feedback correction coefficient FAF varies about a value near 1.0. That is, ideally, the average FAFav of the feedback correction coefficient FAF becomes approximately 1.0.

In some cases, due to an individual difference or variation with time of the air flow meter 221, the injector 162, etc., the average FAFav of the feedback correction coefficient FAF deviates from 1.0. In such a case, the base fuel injection quantity Fbase before feedback correction shifts from the target air-fuel-ratio toward the rich side or the lean side. Such a deviation of FAFav from the value “1.0” can be considered as a steady (long-term) error of the air-fuel-ratio control. In view of this, the learned correction coefficient KG used in the above-described open loop control is acquired on the basis of the deviation of FAFav from the value “1.0.”

Causes of generation of the learned correction coefficient KG include not only mechanical errors as described above, but also change in fuel property; i.e., change in alcohol concentration. This is for the following reason. The theoretical air-fuel-ratio differs between the gasoline F1 and the bio-ethanol F2; therefore, when the alcohol concentration of the fuel F changes, the theoretical air-fuel-ratio for the fuel F also changes. Accordingly, the learned correction coefficient KG is considered to be the sum of a factor (ordinary learned value) KGN determined from the above-described mechanical errors and a factor (fuel learned value) KGF determined from a change in fuel property, as represented by the following equation:

KG=KGN+KGF.

Thus, the fuel property (alcohol concentration) is learned relatively accurately on the basis of the fuel learned value KGF, which is obtained by subtracting the ordinary learned value KGN from the learned correction coefficient KG (in contrast, the fuel property sensor 233 for detecting the alcohol concentration cannot detect the alcohol concentration itself with an accuracy necessary for air-fuel-ratio control, although it can detect relatively well the fact that the fuel property changes within the fuel tank 161 due to refueling or the like). Notably, the initial value of the ordinary learned value KGN is acquired when 100% gasoline or a fuel whose property is known is used as the fuel F. After that, the ordinary learned value KGN is appropriately updated on the basis of a deviation of FAFav which is produced within a predetermined period in which the fuel property is not changed.

Further, in the present embodiment, the combustion conditions, such as compression ratio, are controlled on the basis of the operation condition of the engine 1 (warming up state, load state, etc.) and the fuel property acquired through learning as described above. For example, in the case of a fuel which is high in concentration of alcohol having a high octane number (high concentration fuel), the fuel can be combusted with a higher compression ratio, a higher supercharging pressure, and an advanced ignition timing, as compared with a fuel which is low in concentration of alcohol (low concentration fuel). In view of this, when a high concentration fuel is used, the combustion conditions are set such that the fuel is combusted with a higher compression ratio, a higher supercharging pressure, and an advanced ignition timing; and, when a low concentration fuel is used, the combustion conditions are set such that the fuel is combusted with a lower compression ratio, a lower supercharging pressure, and a delayed ignition timing.

In the case where a high concentration fuel was used before refueling, and a low concentration fuel is charged into the fuel tank 161 as a result of the refueling, if the combustion conditions are maintained to match the high concentration fuel, anomalous combustion such as knocking may occur when injection of the low concentration fuel starts. In order to overcome such a problem, in the present embodiment, when refueling and a change in fuel property are detected, the combustion conditions are shifted toward the low concentration side. This operation effectively suppresses occurrence of anomalous combustion, which would otherwise occur in the above-described case.

Incidentally, when the catalyst bed temperature becomes high, or when the catalyst bed temperature is somewhat high and the operation condition is such that the catalyst bed temperature is apt to increase further, in order to prevent deterioration of or damage to the catalyst converter 159, the fuel injection quantity is corrected to increase. At the time of this quantity increase correction, the open loop control is performed.

As described above, when the combustion conditions are shifted toward the low concentration side in response to detection of refueling and a change in fuel property (especially, when the compression ratio is decrease or the ignition timing is delayed), the catalyst bed temperature increases because the exhaust temperature increases. In order to solve such a problem, in the present embodiment, in such a case, the quantity increase correction for catalyst protection is performed in accordance with the shift.

### SPECIFIC EXAMPLE OF OPERATION

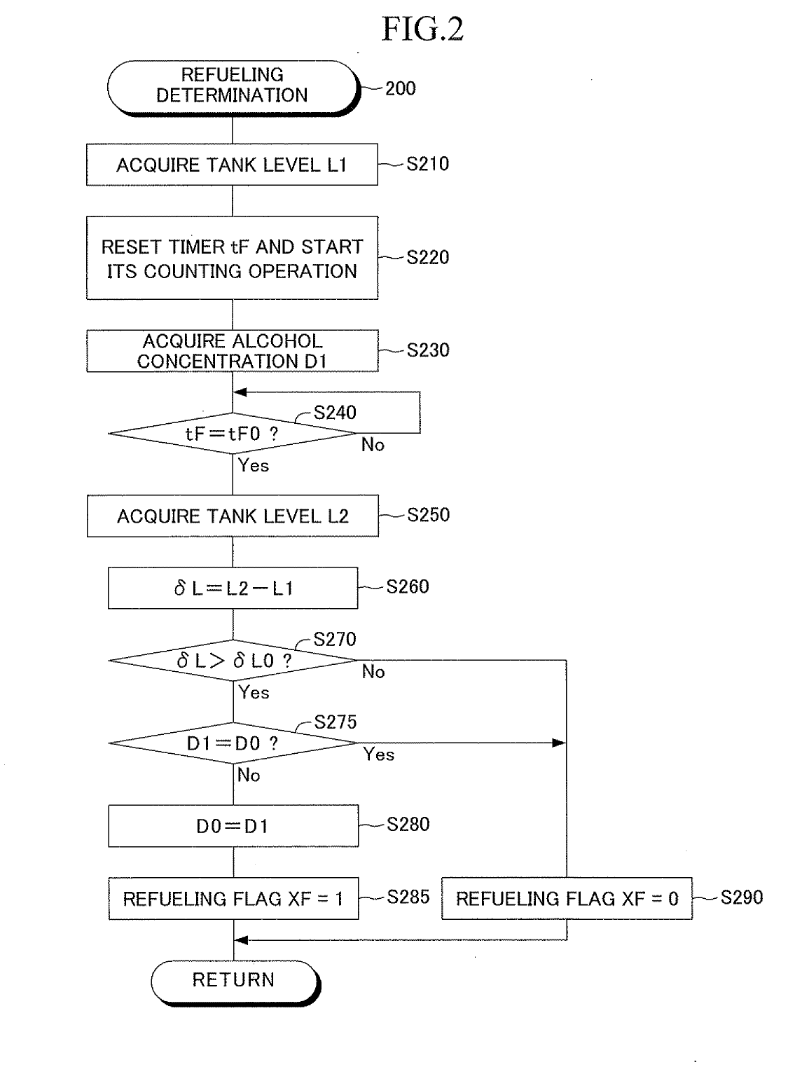

Next, a specific example of operation of the controller 2 of the present embodiment shown in FIG. 1 will be described with reference to the flowcharts of FIGS. 2 to 7. Notably, in the following description of the flowcharts, a term “step” is abbreviated to “S.” In the drawings as well, the term “step” is abbreviated to “S.”

In the present embodiment, the CPU 211 realizes the supply-source-status detection means of the present invention by executing a refueling determination routine 200. Also, the CPU 211 realizes the learning means of the present invention by executing a fuel learning routine 300. Further, the CPU 211 realizes the control means of the present invention by executing a mechanical-compression-ratio setting routine 400, etc.

<<Refueling Determination>>

The CPU 211 executes the refueling determination routine 200 shown in FIG. 2 every time opening and subsequent closing of an unillustrated fuel lid are detected. In this refueling determination routine 200, a refueling flag XF is set (XF=1) when a fuel F whose type differs from that of the previously refueled fuel is refueled this time.

First, in S210, a level L1 of the fuel F within the fuel tank 161 at a certain point in time is acquired. Next, in S220, a timer tF is reset, and counting operation of the timer tF is started. Subsequently, in S230, the alcohol concentration D1 within the fuel tank 161 is acquired. After the count value of the timer tF reaches a predetermined value tF0 (S240=Yes), processing proceeds to S250 and subsequent steps.

In S250, a level L2 of the fuel F within the fuel tank 161 after elapse of a predetermined time tF0 from the acquisition of the level L1 in S210 is acquired. Next, in S260, a level increase δL within the fuel tank 161 is acquired from the difference between L2 and L1. Subsequently, in S270, a determination is made as to whether or not the level increase δL is greater than a predetermined value δL0. Even when refueling is not performed, a variation (error) arises in the level detected by the fuel level sensor 232 within the predetermined time tF0. A value approximately equal to such an error is set as the predetermined value δL0.

When the level increase δL within the fuel tank 161 is greater than the predetermined value δL0 (S270=Yes), it means that refueling was performed (the fuel F was added to the fuel tank 161). In such a case, processing proceeds to S275, and determines whether or not the present detection value D1, which represents the fuel property and detected by the fuel property sensor 233 in S230, is equal to the previous detection value D0. That is, a determination is made as to whether or not the properly of the fuel has changed due to refueling. When the present detection value D1 differs from the previous detection value D0 (S275=No), the properly of the fuel is determined to have changed. Thus, processing proceeds to S280, in which the value of D0 is overwritten with the present detection value D1 so as to prepare for the next refueling. After that, processing proceeds to S285, in which the refueling flag XF is set. The present routine is then ended.

Meanwhile, when the level increase δL within the fuel tank 161 is not greater than the predetermined value δL0 (S270=No), it means that refueling was not performed. In such a case, processing proceeds to S290, in which the refueling flag XF is reset (XF=0). The present routine is then ended. In the case where the fuel F is added to the fuel tank 161 (S270=Yes) but the fuel property does not change (S275=Yes), the same processing is performed.

<<Fuel Property Learning>>

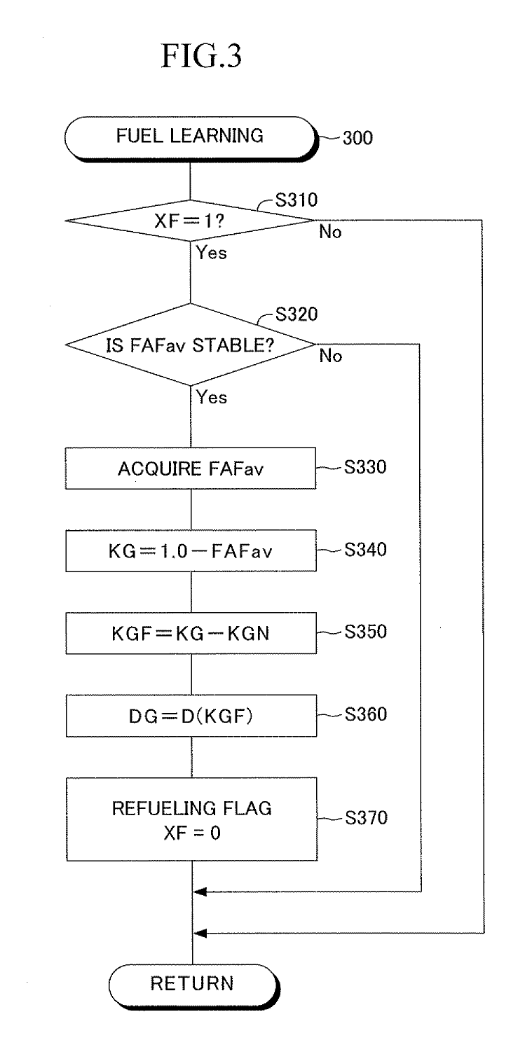

The CPU 211 executes the fuel learning routine 300 shown in FIG. 3 at predetermined intervals after the above-described refueling determination routine 200 is started.

First, in S310, a determination is made as to whether or not the refueling flag XF is set. When the refueling flag XF is not set (S310=No), the current execution of the present routine ends.

When the refueling flag XF is set (S310=Yes), processing proceeds to S320, in which a determination is made as to whether or not the average FAFav of the feedback correction coefficient FAF is stable (whether or not a variation within a predetermined period falls within a predetermined range). When the average FAFav is not stable (S320=No), the current execution of the present routine ends.

When the average FAFav becomes stable (S320=Yes), processing proceeds to S330, in which the present FAFav is acquired. In S340 subsequent thereto, the learned correction coefficient KG is acquired from a deviation of the acquired value of FAFav from the value “1.0.” Next, in S350, the fuel learned value KGF is acquired by subtracting the ordinary learned value KGN from the learned correction coefficient KG. Subsequently, in S360, a fuel property learned value DG (the learned value of the alcohol concentration: unit is %) after completion of the present fuel property learning is acquired on the basis of the fuel learned value KGF newly acquired this time and with reference to a map, a table, or a formula (hereinafter referred to as a “map, etc.”). After the new fuel property learned value DG is acquired in this manner, processing proceeds to S770, in which the refueling flag XF is reset. After that, the current execution of the present routine ends.

<<Mechanical-Compression-Ratio Setting>>

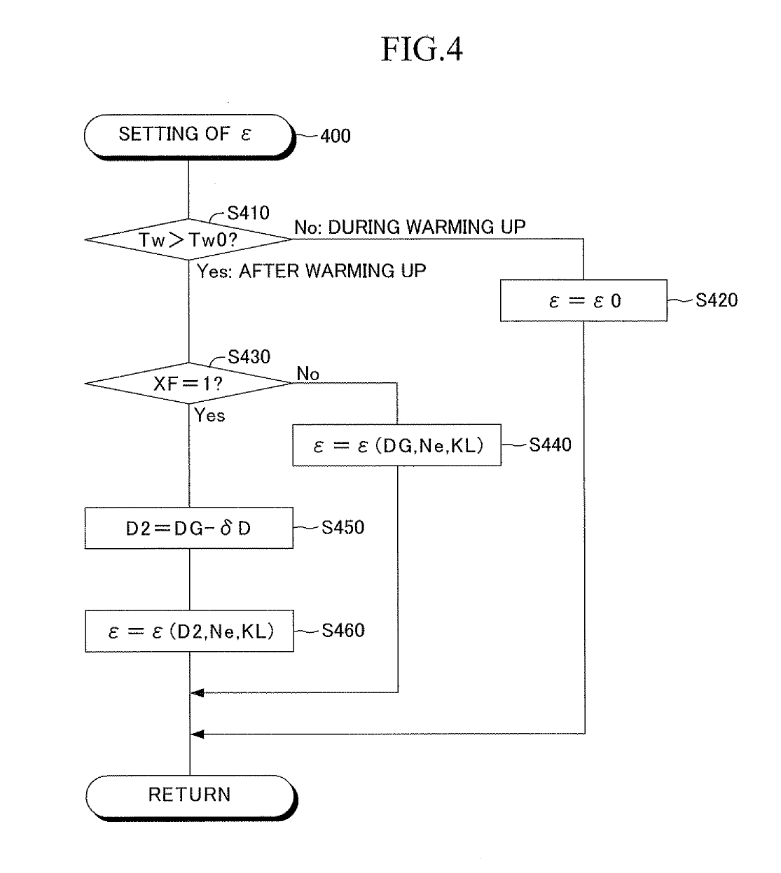

The CPU 211 executes the mechanical-compression-ratio setting routine 400 shown in FIG. 4 at predetermined intervals.

First, in S410, a determination is made as to whether or not the engine 1 has been warmed up (whether or not the cooling-water temperature Tw Tw0). When the engine 1 is being warmed up (S410=No), processing proceeds to S420. In S420, the mechanical compression ratio ε is set to a rather low predetermined value ε0 in order to quicken warming up of the engine 1 and the catalyst converter 159 by increasing the exhaust temperature. Then, the current execution of the present routine ends.

When the engine 1 has been warmed up (S410=Yes), processing proceeds to S430 and subsequent steps. In S430, a determination is made as to whether or not the refueling flag XF is set.

When the refueling flag XF is not set (S430=No), it means that, as described above, the fuel property learning by the fuel learning routine 300 has been completed (including the case where refueling was not performed, the case where the fuel property learning was not necessary because a fuel F having the same property as the previous fuel was refueled, and other similar cases; this also applies to the following description). Therefore, in this case, processing proceeds to S440, in which a target set value of the mechanical compression ratio ε is acquired on the basis of parameters, such as engine speed We and load factor KL, and a map, etc. based on the fuel property learned value DG. After that, the current execution of the present routine ends. Notably, as is well known, the load factor KL can be acquired on the basis of the intake air flow rate Ga, the throttle valve opening TA, or the accelerator pedal operation amount Accp.

When the refueling flag XF is set (S430=Yes), it means that, as described above, the fuel property learning performed by the fuel learning routine 300 after refueling has not yet been completed. Therefore, in this case, processing proceeds to S450, in which a concentration D2 is acquired by subtracting a predetermined value δD (e.g., 20%) from the fuel property learned value DG before completion of the fuel property learning (i.e., determined at the time of the previous learning). Notably, when DG<δD, D2 is set to 0, rather than to a negative value (this also applies to the following description). Subsequently, in S460, the target set value of the mechanical compression ratio ε is acquired on the basis of the parameters, such as engine speed Ne and load factor KL, and a map, etc. based on the alcohol concentration D2 lower than the fuel property learned value DG determined at the time of the previous learning. That is, when the fuel property has changed due to refueling, the mechanical compression ratio ε is shifted to a lower value until completion of the fuel property learning. After that, the current execution of the present routine ends.

<<Ignition Timing Setting>>

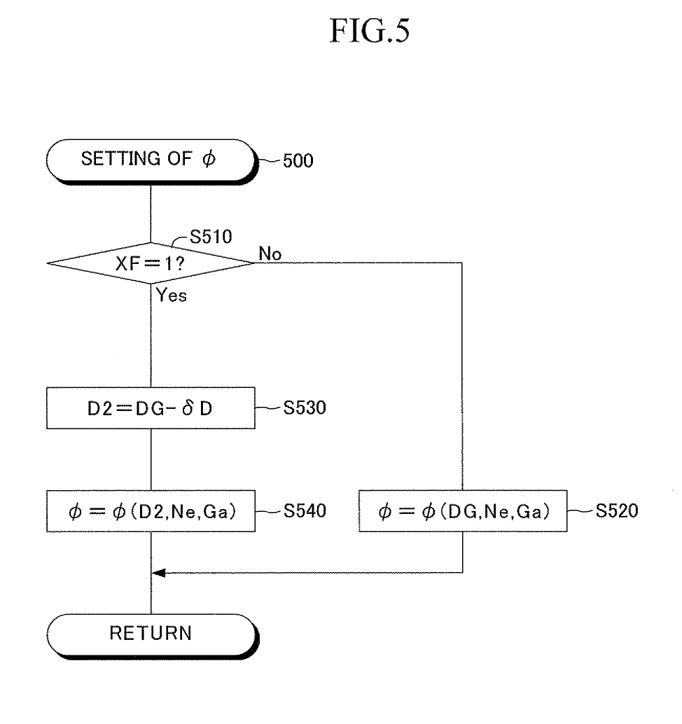

The CPU 211 executes an ignition timing setting routine 500 shown in FIG. 5 at predetermined intervals. In the present routine, first, in S510, a determination is made as to whether or not the refueling flag XF is set.

When the refueling flag XF is not set (S510=No), it means that, as described above, the fuel property learning has been completed. Therefore, in this case, processing proceeds to S520, in which an injection timing φ is determined on the basis of parameters, such as engine speed Ne and intake air flow rate Ga, and a map, etc. based on the fuel property learned value DG. After that, the current execution of the present routine ends.

When the refueling flag XF is set (S510=Yes), it means that, as described above, the fuel property learning after refueling has not yet been completed. Therefore, in this case, processing proceeds to S530, in which, as in the above-described S450, an alcohol concentration D2 which is lower than the fuel property learned value DG determined at the time of the previous learning is acquired; and, in S540 subsequent thereto, the ignition timing φ is set on the basis of the parameters, such as engine speed Ne and intake air flow rate Ga, and a map, etc. based on this alcohol concentration D2. That is, when the fuel property has changed due to refueling, the ignition timing is shifted to the delay side until completion of the fuel property learning. After that, the current execution of the present routine ends.

<<Supercharging Pressure Setting>>

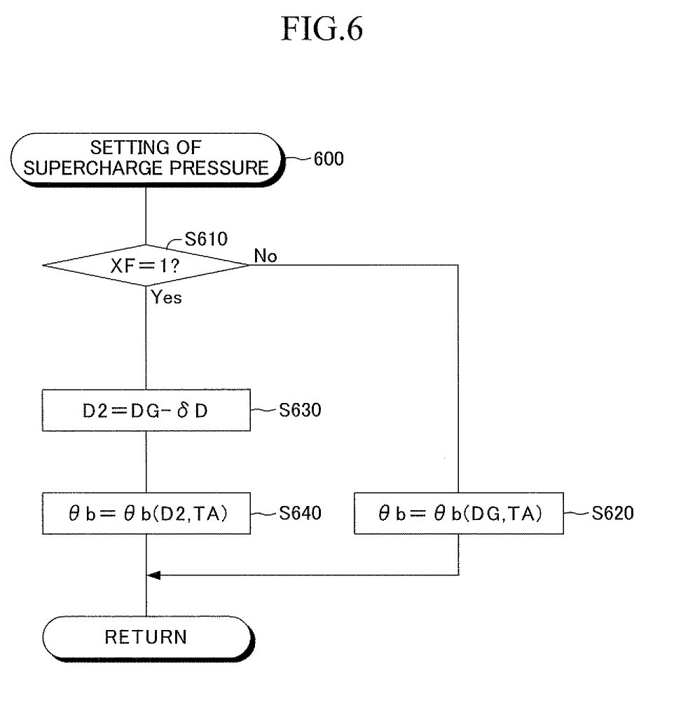

The CPU 211 executes a supercharging pressure setting routine 600 shown in FIG. 6 at predetermined intervals. In the present routine, first, in S610, a determination is made as to whether or not the refueling flag XF is set.

When the refueling flag XF is not set (S610=No), it means that, as described above, the fuel property learning has been completed. Therefore, in this case, processing proceeds to S620, in which an opening Ob of the supercharging pressure control valve 156 is determined on the basis of parameters, such as throttle valve opening TA, and a map, etc. based on the fuel property learned value DG. After that, the current execution of the present routine ends.

When the refueling flag XF is set (S610=Yes), it means that, as described above, the fuel property learning after refueling has not yet been completed. Therefore, in this case, processing proceeds to S630, in which, as in the above-described S450, an alcohol concentration D2 which is lower than the fuel property learned value DG determined at the time of the previous learning is acquired; and, in S640 subsequent thereto, the opening Ob of the supercharging pressure control valve 156 is set on the basis of the parameters, such as throttle valve opening TA, and a map, etc. based on this alcohol concentration D2. That is, when the fuel property has changed due to refueling, the supercharging pressure is lowered until completion of the fuel property learning. After that, the current execution of the present routine ends.

<<Catalyst Protection Quantity Increase Correction>>

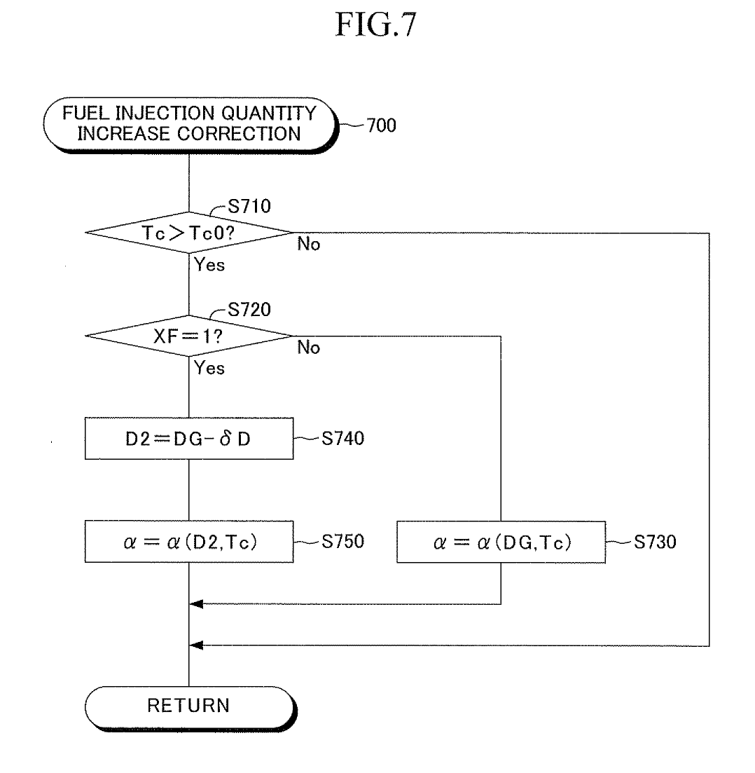

The CPU 211 executes a fuel-injection-quantity increase correction routine 700 shown in FIG. 7 at predetermined intervals.

First, in S710, a determination is made as to whether or not the catalyst bed temperature Tc is higher than a predetermined high temperature Tc0. When the catalyst bed temperature Tc is not higher than Tc0 (S710=No), the processing of S720 and subsequent steps is skipped, and the current execution of the present routine ends. When the catalyst bed temperature Tc is higher than Tc0 (S710=Yes), since the catalyst bed temperature is relatively high, processing proceeds to S720 and subsequent steps in order to perform fuel-injection-quantity increase correction for protecting the catalyst converter 159.

In S720, a determination is made at to whether the refueling flag XF is set. When the refueling flag XF is not set (S720=No), it means that the shift toward the low compression ratio side by the

mechanical-compression-ratio setting routine 400 or the shift toward the delay side by the ignition timing setting routine 500 as described above are not performed. Therefore, in this case, processing proceeds to S730, in which a quantity increase correction value α is acquired on the basis of parameters, such as catalyst bed temperature Tc, and a map. etc., based on the fuel property learned value DG. That is, quantity increase correction as usual is executed. After that, the current execution of the present routine ends.

When the refueling flag XF is set (S720=Yes), it means that, as described above, the shift toward the low compression ratio side by the mechanical-compression-ratio setting routine 400 or the shift toward the delay side by the ignition timing setting routine 500 is being performed. In this case, due to an increase in the exhaust temperature, the degree of increase in the catalyst bed temperature may increase. Therefore, in this case, processing proceeds to S740, in which, as in the above-described S450, an alcohol concentration D2 which is lower than the fuel property learned value DG determined at the time of the previous learning is acquired; and, in S750 subsequent thereto, the quantity increase correction value α is acquired on the basis of the parameters, such as catalyst bed temperature Tc, and a map, etc. based on this alcohol concentration D2. That is, when the fuel property has changed due to refueling, the increase amount is increased until completion of the fuel property learning. After that, the current execution of the present routine ends.

### ACTION AND EFFECTS ATTAINED BY CONFIGURATION OF EMBODIMENT

In the present embodiment, when performance of refueling is detected, until learning of the fuel property is completed, the combustion conditions, such as the compression ratio and the ignition timing, are shifted toward the low alcohol concentration side; i.e., such that occurrence of anomalous combustion, such as knocking, is suppressed. With this operation, occurrence of anomalous combustion, such as knocking, in a period before completion of re-learning of the property of fuel is suppressed to a possible extent. Therefore, even when the property of fuel greatly changes due to, for example, refueling, the operation control of the engine 1 can be performed properly.

In the present embodiment, the above-described processing is not performed automatically when refueling is performed, but performed when a change in the property of fuel due to refueling is detected. That is, even when refueling is performed, the combustion control is performed under ordinary combustion conditions if the property of fuel does not change. With this operation, effective operation control can be performed for the engine 1.

In the present embodiment, when the combustion conditions are shifted upon detection of refueling and a change in the property of fuel such that the compression ratio is lowered and the ignition timing is delayed, the fuel-injection-quantity increase correction for protecting the catalyst converter 159 is performed so as to conform to the shift. With this operation, even when the above-described combustion condition shift is performed, excessive increase of the catalyst bed temperature is avoided, and the performance of the catalyst converter 159 can be maintained well.

### OTHER EMBODIMENTS

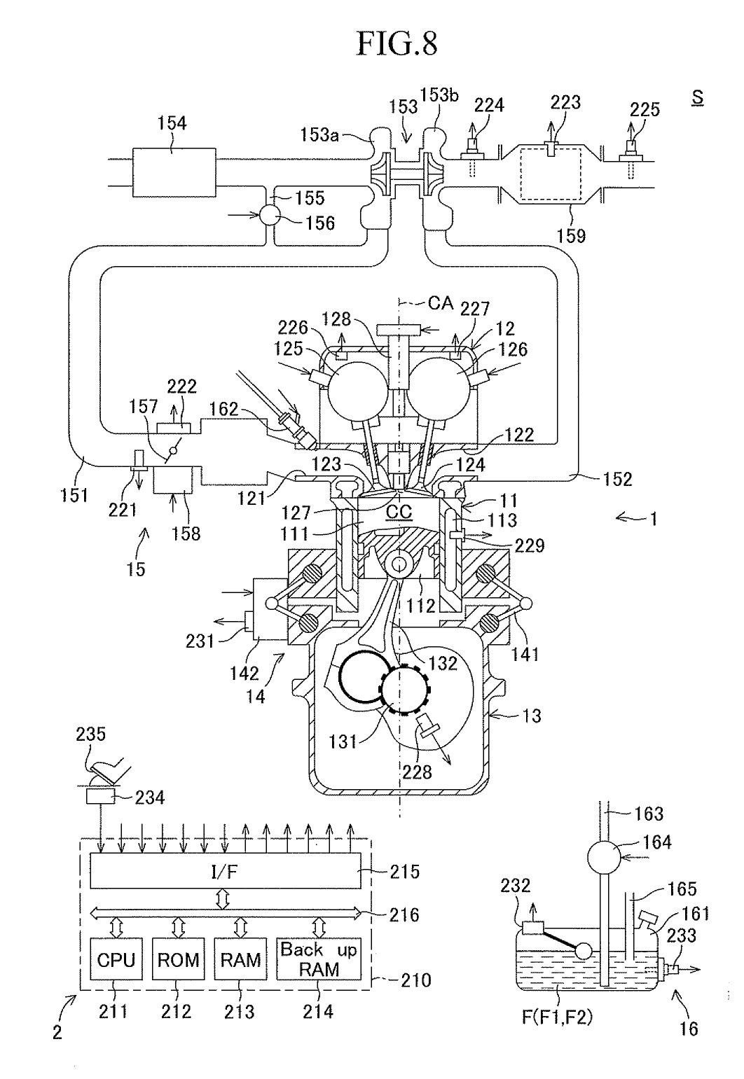

FIG. 8 is a schematic diagram showing the overall configuration of a system S according to another embodiment which has a configuration modified from the configuration of the embodiment shown in FIG. 1. Notably, for the present embodiment, except for the following description, descriptions of the configuration, operation, action, and effects in the above-described first embodiment are incorporated herein by reference, so long as no technical inconsistencies are involved.

<<Configuration>>

In the present embodiment, the fuel supply system 16 is configured to circulate fuel between the fuel tank 161 and the injector 162 (for example, a common-rail-type fuel injection system has such a configuration). Specifically, the fuel supply system 16 includes a return pipe 165. This return pipe 165 is configured to return to the fuel tank 161 the fuel F which was not injected from the injector 162.

<<Outline of Operation, Action, and Effects>>

(1) When the alcohol concentration is high (in particular, when the alcohol concentration is about 80% or higher), the startability of the engine 1 deteriorates (in particular, at the time of cold start). Further, at a point in time when the engine 1 is refueled and re-started after the engine 1 was stopped for fueling, the previous fuel F (used at the time of the latest fuel property learning) may remain within the delivery pipe 163.

Therefore, in the case where the alcohol concentration learned value before refueling is high, if the combustion conditions are shifted toward the low concentration side (a low compression ratio, etc.) at the time of startup immediately after the refueling, the startability may further deteriorate (in particular, at the time of cold start). In view of the above, in such a case, the shifting of the combustion conditions toward the low concentration side is delayed for a predetermined time. With this operation, occurrence of startup failure can be suppressed to a possible degree.

(2) As described above, at a point in time when the engine 1 is refueled and re-started after the engine was stopped for refueling, assumedly, the previous fuel F remains within the delivery pipe 163. If the fuel pump 164 is driven and circulation of the fuel F is started in this state when an ignition switch is turned on before startup of the engine 1 is requested, the fuel property at the time when the startup is requested becomes uncertain, and proper operation control becomes difficult to perform.

In order to solve such a problem, in the present embodiment, when refueling and a change in the property of fuel property are detected, the state where the fuel pump 164 is stopped is maintained (start of driving of the fuel pump 164 is delayed) until startup of the engine is requested, even if the ignition switch is turned on. With this operation, proper operation control can be performed after refueling. Further, occurrence of startup failure can be suppressed to a possible degree.

### SPECIFIC EXAMPLE OF OPERATION

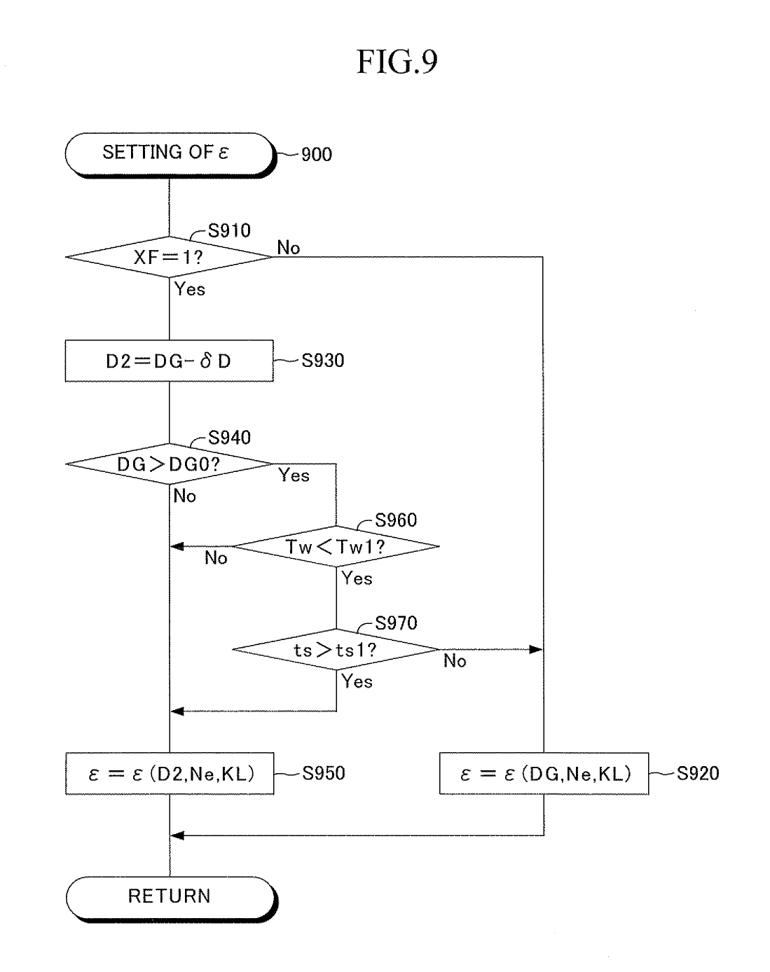

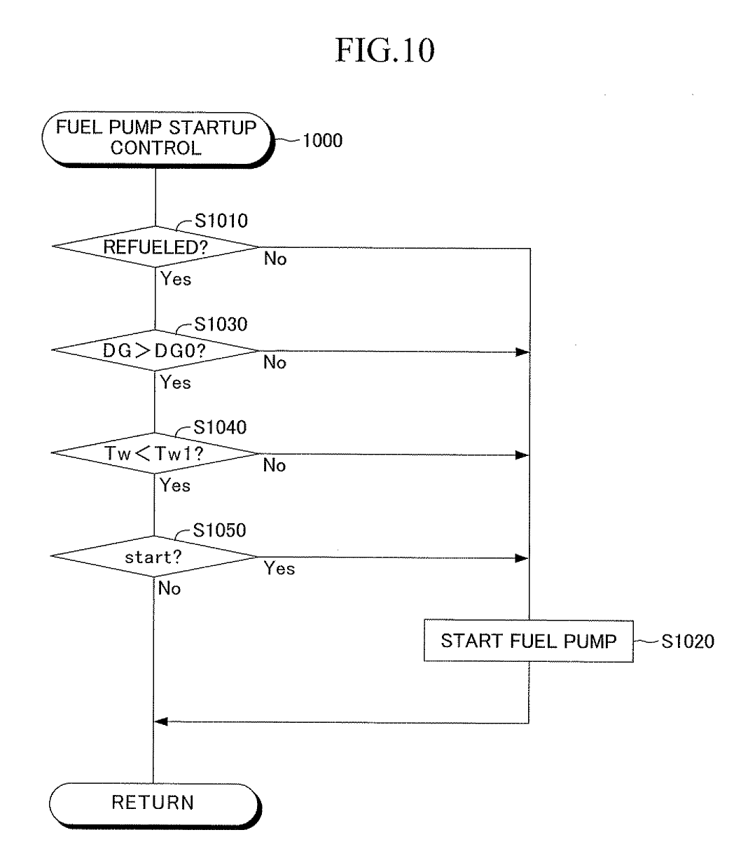

FIGS. 9 and 10 are flowcharts showing a specific example of operation of the controller 2 in the configuration shown in FIG. 8.

<<<Combustion Condition Control>>>

The CPU 211 executes a mechanical-compression-ratio setting routine 900 shown in FIG. 9 at predetermined intervals. In the present routine, first, in S910, a determination is made as to whether or not the refueling flag XF is set.

When the refueling flag XF is not set (S910=No), it means that, as described above, the fuel property learning has been completed. Therefore, in this case, processing proceeds to S920, in which a target set value of the mechanical compression ratio ε is acquired through use of a map. etc., based on the fuel property learned value DG. After that, the current execution of the present routine ends.

When the refueling flag XF is set (S910=Yes), it means that, as described above, the fuel property learning after refueling has not yet been completed. Therefore, in this case, processing proceeds to S930, in which an alcohol concentration D2 which is lower than the fuel property learned value DG determined at the time of the previous learning is acquired. After that, processing proceeds to S940, in which a determination is made as to whether the fuel property learned value DG determined at the time of the previous learning is higher than a predetermined concentration DG0 (e.g., 80%).

When the fuel property learned value DG at the time previous learning is equal to or less than the predetermined concentration DG0 (S940=No), processing proceeds to S950, in which the target set value of the mechanical compression ratio ε is acquired by use of a map, etc. based on the alcohol concentration D2 lower than the fuel property learned value DG determined at the time of the previous learning. That is, when the property of fuel changes due to refueling, the mechanical compression ratio ε is shifted to a lower value until completion of the fuel property learning. After that, the current execution of the present routine ends.

Meanwhile, when the fuel property learned value DG at the time previous learning is greater than the predetermined concentration DG0 (S940=Yes), processing proceeds to S960, in which a determination is made as to whether or not the cooling-water temperature is lower than a predetermined low temperature Tw1. As the predetermined temperature Tw1, the upper limit value of a temperature range in which use of a map, etc. based on the alcohol concentration D2 increases the possibility of occurrence of startup failure is selected.

When the cooling-water temperature is not lower than the predetermined temperature Tw1 (S960=No), processing proceeds to S950, in which processing similar to the above-described processing is performed. When the cooling-water temperature is lower than the predetermined temperature Tw1 (S960=Yes), processing proceeds to S970, in which a determination as to whether or not a predetermined time ts1 has elapsed after startup is made on the basis of the count value of a timer ts. This timer ts is a timer which is reset at the time of startup and then starts its counting operation.

In the case where the present point in time is before startup or the predetermined time ts1 has not yet elapsed after the startup (S970=No), processing proceeds to S920, in which the target set value of the mechanical compression ratio ε is acquired through use of a map, etc. based on the fuel property learned value DG determined at the time of the previous learning. Meanwhile, when the predetermined time ts1 has elapsed after the startup (S970=Yes), processing proceeds to S950, in which the target set value of the mechanical compression ratio ε is acquired through use of a map, etc. based on the alcohol concentration D2, which is lower than the fuel property learned value DG determined at the time of the previous learning. After that, the current execution of the present routine ends. That is, execution of the processing of shifting the compression ratio toward the low alcohol concentration side in S950 is delayed until the predetermined time ts1 elapses after the startup.

As described above, in the present embodiment, the CPU 211 realizes the control means of the present invention by executing the mechanical-compression-ratio setting routine 900. Further, the CPU 211 realizes the temperature acquisition means of the present invention by executing the processing of acquiring the cooling-water temperature Tw on the basis of the output of the cooling-water temperature sensor 229 (see S960). Notably, combustion conditions other than the mechanical compression ratio can be controlled in the same manner (in the same manner as in the above-described first embodiment).

<<<Fuel-Pump-Startup Control>>>

The CPU 211 executes a fuel-pump-startup control routine 1000 shown in FIG. 10 when the ignition switch is turned on, and at predetermined intervals thereafter until the fuel pump 164 is started (this routine is not executed after the fuel pump 164 is started).

First, in S1010, a determination is made as to whether or not refueling was performed. This determination can be performed through use of, for example, a fuel lid open/close detection flag which is set when opening/closing of the fuel lid is detected, and is reset when the engine is started. In the case where refueling was not performed (S1010=No), processing proceeds to S1020, in which the fuel pump 164 is started. After that, the current execution of the present routine ends.

In the case where refueling was performed (S1010=Yes), processing proceeds to S1030, in which a determination is made as to whether or not the fuel property learned value DG determined at the time of the previous learning is higher than the predetermined concentration DG0. When the fuel property learned value DG is equal to or less than the predetermined concentration DG0 (S1030=No), processing proceeds to S1020, in which the fuel pump 164 is started. After that, the current execution of the present routine ends. Meanwhile, when the fuel property learned value DG is greater than the predetermined concentration DG0 (S1030=Yes), processing proceeds to S1040, in which a determination is made as to whether or not the cooling-water temperature is lower than the predetermined temperature Tw1.

When the cooling-water temperature is not lower than the predetermined temperature Tw1 (S1040=No), processing proceeds to S1020, in which the fuel pump 164 is started. After that, the current execution of the present routine ends. Meanwhile, when the cooling-water temperature is lower than the predetermined temperature Tw1 (S1040=Yes), processing proceeds to S1050, in which a determination is made as to whether or not startup of the engine has been requested.

When startup of the engine has not yet been requested (S1050=No), the current execution of the present routine ends, and, after elapse of a predetermined time, the present routine is executed again. When startup of the engine has been requested (S1050=Yes), processing proceeds to S1020, in which the fuel pump 164 is started. After that, the current execution of the present routine ends.

As descried above, in the present embodiment, the CPU 211 realizes the pump control means of the present invention by executing the fuel-pump-startup control routine 1000.

<Modifications>

The above-described embodiments are, as mentioned previously, mere examples of the concrete configuration of the present invention which the applicant of the present invention considered to be best at the time of filing the present application. Therefore, the present invention is not limited to the above-described embodiments. Various modifications to the concrete configurations of the above-described embodiments are possible so long as the invention is not modified in essence.

Several modifications will next be exemplified. In the following description of the modifications, each of constituent elements having the same configuration and function as those of the corresponding constituent element of the above-described embodiments is given the same name and the same reference numeral. For description of these constituent elements, description of the above-described embodiments is incorporated herein by reference, so long as no technical inconsistencies are involved.

Needless to say, even modifications are not limited to those exemplified below. The above-described embodiment and the following modifications should not be construed as limiting the present invention. Such limiting construal unfairly impairs the interests of an applicant who is motivated to file as quickly as possible under the first-to-file system; unfairly benefits imitators; and is thus impermissible.

Needless to say, the configurations of the above-described embodiments, and the configurations of the following modifications can be applied in appropriate combination so long as no technical inconsistencies are involved.

(1) The present invention is not limited to the structures disclosed in the above-described embodiments. Fuel to be used is not limited to gasoline and bio-ethanol. For example, the present invention can be advantageously applied to diesel engines which can use bio-fuel. No limitation is imposed on the number of cylinders, the arrangement of cylinders (straight, V-type, horizontally opposed), the fuel injection scheme (port injection, cylinder direct injection).

The structure of the variable compression ratio mechanism 14 is not limited to that employed in the above-described embodiments. For example, the engine 1 may be configured such that the connecting rod 132 has a multi-link structure, and the mechanical compression ratio is changed by means of changing the bending state of the connecting rod 132 (see Japanese Patent Application Laid-Open (kokai) No. 2004-156541. etc.).

The fuel injection scheme is not limited to that employed in the above-described embodiments in which fuel is injected into the intake port 121 (port injection), and may be a cylinder injection scheme in which fuel is injected directly into the combustion chamber CC. Further, as described above, the present invention can be favorably applied to a common rail scheme.

(2) Further, the present invention is not limited to the specific examples of control disclosed in the above-described embodiments. For example, in the first embodiment, performing at least one of the programs shown by the flowcharts of FIGS. 3 to 5 is sufficient. Alternatively, the program shown by the flowchart of FIG. 9 may be performed in the configuration of the first embodiment.

A portion of the steps of each flowchart may be omitted, without departing from the scope of the present invention (for example, S230, S275, and S280 of FIG. 2, S960 of FIG. 9, etc.) When the S230, S275, and S280 of FIG. 2 are omitted, the fuel property sensor 233 can be omitted. That is, when the fact that refueling was performed is detected, the above-described combustion condition shift may be performed irrespective of whether or not the property of fuel is changed.

“Predetermined values,” such as δD in S450 of FIG. 4, etc. and the predetermined concentration DG0 in S940 of FIG. 9, can be set to proper values in accordance with the structure, specifications, etc. of the engine 1. Further, in FIG. 4, etc., instead of using the valued D2 obtained by subtracting the predetermined value δD from the fuel property learned value DG determined at the time of the previous learning, a specific alcohol concentration (i.e., 5% or 10%) corresponding to a predetermined low concentration fuel (e.g., E5 or E10) may be used so as to perform combustion condition control (shift toward the low concentration side) when refueling is detected.

The present invention is applicable to the case where, instead of the mechanical compression ratio controlled in the above-described embodiments, an actual compression ratio may be controlled through use of the variable intake valve timing apparatus 125 and the variable exhaust valve timing apparatus 126. Further, the operation of changing the actual compression ratio in accordance with the operation condition may be performed through combined performance of an operation of changing the mechanical compression ratio by means of the variable compression ratio mechanism 14, and an operation of changing the valve timing by means of the variable intake valve timing apparatus 125 and the variable exhaust valve timing apparatus 126. The present invention can be favorably applied to such a case.

In stead of using the temperature detected by the catalyst bed temperature sensor 223, there may be used an onboard estimated catalyst temperature (an estimated value of catalyst convergent temperature) determined from engine load and engine speed.

(3) Modifications which are not specifically described herein naturally fall within the scope of the present invention, so long as they do not change the essential portion of the present invention.

Those components which partially constitute the means for solving the problems to be solved by the invention and are expressed operationally and functionally encompass not only the specific structures disclosed in the above embodiments and modifications but also any other structures that can implement the operations and functions of the components.

1. An internal combustion engine controller for controlling operation of an internal combustion engine configured such that it can use a fuel which may contain a first component which is independently usable for combustion and a second component which is independently usable for combustion and which is higher in octane number than the first component, the controller comprising:
a learning section which learns a concentration of the second component as a property of the fuel;
a control section which controls combustion conditions within a combustion chamber on the basis of the concentration of the second component learned by the learning section; and
a supply-source-status detection section which detects a change in the status of a supply source for the fuel to a fuel injector which injects the fuel,
wherein, when the supply-source-status detection section detects a change in the status, the control section controls the combustion conditions based on a concentration of the second component shifted to the direction of lower concentration suppressing occurrence of knocking within the combustion chamber compared to the combustion conditions based on the concentration of the second component learned before the detection until the learning section learns the concentration of the second component again.

2. An internal combustion engine controller according to claim 1, wherein the supply-source-status detection section detects refueling.

3. An internal combustion engine controller according to claim 1, further comprising a pump control section which controls operation of a fuel supply pump inserted into a fuel supply passage which connects the fuel injector and the supply source together,
wherein, when the supply-source-status detection section detects a change in the status, the pump control section stops the fuel supply pump until startup of the internal combustion engine is requested.

4. An internal combustion engine controller according to claim 1, wherein
the supply-source-status detection section detects a change in the concentration of the second component on the basis of an output of a fuel property sensor configured to produce an output corresponding to the concentration; and
when the supply-source-status detection section detects a change in the concentration, the control section controls the combustion conditions based on a concentration of the second component shifted to the direction of lower concentration suppressing occurrence of knocking within the combustion chamber compared to the combustion conditions based on the concentration of the second component learned before the detection until the learning section learns the concentration of the second component again.

5. (canceled)

6. An internal combustion engine controller according to claim 1, wherein
the fuel contains gasoline as the first component and alcohol as the second component; and
when an alcohol concentration of the fuel learned before the detection of the change is higher than a predetermined value, the control section controls, for a predetermined time, the combustion conditions on the basis of the alcohol concentration learned before the detection of the change, and then controls the combustion conditions on the basis of an alcohol concentration lower than the learned alcohol concentration.

7. An internal combustion engine controller according to claim 6, further comprising a temperature acquisition section which acquires a temperature associated with operation of the internal combustion engine, wherein
the control section controls the combustion conditions on the basis of the alcohol concentration learned before the detection of the change when the alcohol concentration is higher than the predetermined value and the temperature is lower than a predetermined temperature.

8. An internal combustion engine controller according to claim 1, wherein
the internal combustion engine is configured such that its mechanical compression ratio can be changed; and
the control section controls the mechanical compression ratio on the basis of the fuel property learned by the learning section.

9. An internal combustion engine controller according to claim 1, wherein
the control section controls ignition timing on the basis of the fuel property learned by the learning section.

10. An internal combustion engine controller according to claim 1, wherein
the internal combustion engine is equipped with a supercharger; and
the control section controls supercharging pressure of the supercharger on the basis of the fuel property learned by the learning section.

11. An internal combustion engine controller for controlling operation of an internal combustion engine configured such that it can use a fuel which may contain a first component which is independently usable for combustion and a second component which is independently usable for combustion and which is higher in octane number than the first component, the internal combustion engine being capable of changing its mechanical compression ratio, the controller comprising:
a learning section which learns, as a property of the fuel, a concentration of the second component on the basis of a learned correction coefficient acquired in air-fuel-ratio feedback control;
a control section which controls the mechanical compression ratio on the basis of the concentration of the second component learned by the learning section; and
a supply-source-status detection section which detects a change in the status of a supply source for the fuel to a fuel injector which injects the fuel,
wherein, when the supply-source-status detection section detects a change in the status, until the learning section learns the concentration of the second component again, the control section renders the mechanical compression ratio smaller than a mechanical compression ratio corresponding to the concentration of the second component learned before the detection of the change.

12. An internal combustion engine controller for controlling operation of an internal combustion engine configured such that it can use a fuel which may contain a first component which is independently usable for combustion and a second component which is independently usable for combustion and which is higher in octane number than the first component, the controller comprising:
a learning section which learns, as a property of the fuel, a concentration of the second component on the basis of a learned correction coefficient acquired in air-fuel-ratio feedback control;
a control section which controls ignition timing on the basis of the concentration of the second component learned by the learning section; and
a supply-source-status detection section which detects a change in the status of a supply source for the fuel to a fuel injector which injects the fuel,
wherein, when the supply-source-status detection section detects a change in the status, until the learning section learns the concentration of the second component again, the control section delays the ignition timing from an ignition timing corresponding to the concentration of the second component learned before the detection of the change.

13. An internal combustion engine controller for controlling operation of an internal combustion engine configured such that it can use a fuel which may contain a first component which is independently usable for combustion and a second component which is independently usable for combustion and which is higher in octane number than the first component, the internal combustion engine being equipped with a supercharger, the controller comprising:
a learning section which learns, as a property of the fuel, a concentration of the second component on the basis of a learned correction coefficient acquired in air-fuel-ratio feedback control;
a control section which controls supercharging pressure of the supercharger on the basis of the concentration of the second component learned by the learning section; and
a supply-source-status detection section which detects a change in the status of a supply source for the fuel to a fuel injector which injects the fuel,
wherein, when the supply-source-status detection section detects a change in the status, until the learning section learns the concentration of the second component again, the control section renders the supercharging pressure lower than a supercharging pressure corresponding to the concentration of the second component learned before the detection of the change.
